(19) United States
(12) Patent Application Publication
(10) Pub. No.: US 2003/0043452 A1
(43) Pub. Date: Mar. 6, 2003

(54) Device for the frequency conversion of a fundamental laser frequency to other frequencies

(75) Inventor: Peter Heist, Jena (DE)

Correspondence Address: Gerald H. Kiel, Esq., REED SMITH, LLP, 375 Park Avenue, New York, NY, 10152-1799, US

(73) Assignee: JENOPTIK Laser, Optik, Systeme GmbH

(21) Appl. No.: 10/233,080

(22) Filed: Aug. 30, 2002

(30) Foreign Application Priority Data
Aug. 31, 2001 (GB) 101 43 709.9

(51) Int. Cl. G02F 1/35; G02F 2/02; H01S 3/10

(52) U.S. Cl. 359/326; 372/21

(57) ABSTRACT

It is the object of a device for converting a fundamental laser frequency to other frequencies to further increase the conversion efficiency in successive nonlinear processes at a low cost with respect to material and alignment and in a space-saving compact arrangement and to make use of the advantages of noncritical phase matching for this purpose. Between two nonlinear optical crystals for generating a first new frequency and for frequency mixing of a pair of laser beams which is generated in the first crystal and whose laser beams are polarized perpendicular to one another, there is arranged another birefringent crystal which is penetrated by the pair of laser beams and in which nonlinear optical characteristics are prevented, so that the pair of laser beams exits from the birefringent crystal with unchanged frequencies. One of the two laser beams, as extraordinary polarized laser beam, undergoes a walk-off in the birefringent crystal, which walk-off is directed opposite to the walk-off occurring in one of the two crystals. Devices of this kind which make use of nonlinear optical processes for frequency conversion are used particularly in solid state lasers.

### CROSS-REFERENCE TO RELATED APPLICATIONS

This application claims priority of German Application No. 101 43 709.9, filed Aug. 31, 2001, the complete disclosure of which is hereby incorporated by reference.

### BACKGROUND OF THE INVENTION

a) Field of the Invention

The invention is directed to a device for converting a fundamental laser frequency to other frequencies with successively arranged nonlinear optical crystals, of which a first crystal is provided for generating a first new frequency and a second crystal is provided for generating a second new frequency by frequency mixing, and a pair of laser beams generated in the first crystal has laser beams which are polarized perpendicular to one another, one of which laser beams, as extraordinary polarized laser beam, undergoes a walk-off in one of the two nonlinear optical crystals.

b) Description of the Related Art

Devices of the type mentioned above which make use of nonlinear optical processes for frequency conversion are used particularly in solid state lasers, e.g., B. Ruffing, A. Nebel, R. Wallenstein, “High-power picosecond LiB₃O₅ optical parametric oscillators tunable in the blue spectral range”, Appl. Phys. B 72, (2001): 137-149.

Frequency-multiplied solid state lasers of this type have proven particularly advantageous for generating laser radiation with wavelengths in the visible (VIS) or ultraviolet (UV) spectral range. Typical frequency conversion processes are second harmonic generation (SHG), in which the frequency of the laser radiation is doubled, that is, the wavelength is halved, and sum frequency generation (SFG) of two laser beams. These nonlinear optical processes (NLO processes) are often applied in solid state lasers whose frequencies correspond to an emission wavelength in the near infrared range around 1 μm. For example, an Nd:YVO₄ laser emits at a fundamental wavelength of λ₁=1064 nm.

NLO processes are particularly effective when the output laser emits a pulse or train of pulses with high peak output in the kW range. Conventional methods for pulse generation such as Q-switching and mode coupling are sufficiently well known to the person skilled in the art.

This is also the case with phase matching which is a necessary condition for efficient frequency conversions. This is generally achieved by special orientation of the nonlinear birefringent crystal and/or by selecting a suitable crystal temperature and causes the wave vectors of three participating waves to meet the condition k₃=k₁+k₂ (for SHG, k₃=2k₁). Because of the birefringent characteristics of the crystal, the direction of energy flow (direction of the Poynting vector s) of the extraordinary (e) polarized wave does not coincide with that of the wave vector k. The energy of the extraordinary polarized wave runs away from the ordinary polarized wave (o) at the walk-off angle, as it is called. At the end of the crystal, both laser beams are separated by distance δ; they have a spatial walk-off angle. This phenomenon occurs in all nonlinear optical crystals in which critical phase matching (CPM) is carried out.

Accordingly, in case of critical phase matching with SHG and the third harmonic (THG) in an LBO crystal, the fundamental wave (λ₁=1064 nm) is ordinary-polarized, but the frequency-doubled radiation (λ₂=532 nm) is extraordinary-polarized, so that the interaction of the waves is no longer ensured over the full length of the crystal; the efficiency of the conversion decreases and unwanted deformations of the spatial beam profile occur.

Therefore, technical solutions must be found by which the walk-off can be reduced or compensated.

Noncritical phase matching in which this walk-off phenomenon does not occur and which has numerous advantages over critical phase matching is particularly well suited. These advantages consist in a high conversion efficiency, insensitivity to angular tilting, and the achievement of radial symmetry and beam quality also in the generated extraordinary polarized laser beam.

Further, with a conversion rate equal to that of critical phase matching, larger beam cross sections are possible with correspondingly longer crystals, so that problems relating to high output densities, such as destruction of antireflective layers, are minimized.

While noncritical phase matching can be achieved only in a limited number of nonlinear optical crystals and at determined wavelengths of the interacting laser beams, there also exist in practice usable solutions, e.g., the LBO crystal, which make possible a frequency doubling of the fundamental wave of 1064 nm at a crystal temperature of about 150° C.

However, noncritical phase matching can not be used for tripling (THG) the laser frequency. Since critical phase matching is unavoidable in this case, various arrangements have already been described for walk-off compensation.

U.S. Pat. No. 5,047,668 discloses an optical parametric oscillator for walk-off compensation which contains a pair of identical nonlinear crystals along the cavity axis for one and the same nonlinear process. The optical axes of this pair of identical nonlinear crystals enclose an angle of 2Θ, where Θ, as the angle between the propagation direction of the laser beam (laser beam axis) and the optical axis, is positively oriented in the first crystal but negatively oriented in the second crystal. The walk-off in the first crystal is compensated by the “walk-on” in the second crystal.

However, a solution of this kind is not usable when there is a succession of different nonlinear processes such as second harmonic generation followed by sum frequency generation.

U.S. Pat. No. 5,835,513 describes a Q-switched laser with extracavity nonlinear crystals, of which a first crystal is provided for generating the second harmonic and a second crystal is provided for generating the third harmonic. Both crystals are critically phase-matched and oriented in such a way that the walk-off in the first crystal compensates the walk-off in the second crystal. The teaching of U.S. Pat. No. 5,047,668 is expanded to two different nonlinear crystals and processes.

The critical phase matching of the first crystal is disadvantageous compared to noncritical phase matching.

Further, it is known from U.S. Pat. No. 5,384,803 to use an arrangement of two optical wedges between the two nonlinear crystals in order to change the separation between two beams of different wavelength. While such an arrangement does make it possible to recombine the beams that are spatially separated by the walk-off at the output of the first crystal in order to make the subsequent sum frequency generation more efficient, the proposed solution requires considerable space due to the comparatively weak dispersive characteristics of the optical wedge. For example, if the fundamental wave (λ₁=1064) and second harmonic (λ₂=532) are separated by 150 μm (typical value following an SHG crystal), a 3-degree wedge causes them to be joined only after about 25 cm.

Finally, B. Ruffing, A. Nebel, R. Wallenstein, “High-power picosecond LiB₃O₅ optical parametric oscillators tunable in the blue spectral range”, Appl. Phys. B 72, (2001): 137-149, discloses that the beams incident on the nonlinear crystal with orthogonal polarization (o and e) are adjusted separately and recombined following a divergence caused by the walk-off. While the optimal spatial overlapping is adjusted by mirrors, a delay path comprising beam splitters and mirrors is provided for optimal temporal overlapping. Both the spatial and temporal walk-off can be compensated in this way, in principle, but at the cost of considerable expenditure on material because of the many optical components which, moreover, cause output losses due to the use of dichroic mirrors, and because a comparatively large amount of space is required as well as increased expenditure on adjustment and stability of the optomechanical components.

In addition to the spatial walk-off described above, another phenomenon occurs during the frequency conversion of ultrashort laser pulses with pulse durations in the picosecond range and below. This phenomenon takes the form of a temporal offset between the individual pulses to be superimposed which can be referred to as temporal walk-off and which likewise has disadvantages for conversion efficiency. The effect becomes noticeable when the pulse length reaches an order of magnitude at which different group velocities of the interacting light pulses having different wavelengths and polarization impair the superposition of pulses and cause them to run apart from one another.

Only the arrangement described in the last publication cited above is partly capable of compensating this temporal offset by means of the built-in delay path, whereas U.S. Pat. Nos. 5,047,668, 5,835,513 and 5,384,803 are not suitable for this purpose.

### OBJECT AND SUMMARY OF THE INVENTION

Therefore, it is the primary object of the invention to further increase the conversion efficiency in successive nonlinear processes at a low cost with respect to material and alignment and in a space-saving compact arrangement and to make use of the advantages of noncritical phase matching for this purpose.

According to the invention, this object is met by a device of the type mentioned in the beginning in that a birefringent crystal is arranged between the two nonlinear optical crystals, which birefringent crystal is penetrated by the pair of laser beams and in which nonlinear optical characteristics are prevented, so that the pair of laser beams exits from the birefringent crystal with unchanged frequencies. In the birefringent crystal, the extraordinary polarized laser beam undergoes a walk-off which is directed opposite to the walk-off occurring in one of the two crystals.

In order to prevent nonlinear optical characteristics, birefringent materials can be used in which this characteristic is not noticeable. However, crystals in which the nonlinear characteristics are deliberately suppressed by a selected orientation of the crystal axis can also be used.

The invention provides an extremely compact optical element in the form of a thin birefringent crystal plate which is suitable for compensating spatial walk-off as well as temporal walk-off due to large differences in the refractive index. Therefore, the two nonlinear crystals can be arranged very close together. The entire arrangement can still be maintained compact even when an imaging element for focusing is required in the second nonlinear crystal in some cases.

The invention also concerns a solid state laser with extracavity nonlinear optical crystals for converting the frequency of a fundamental laser frequency into other frequencies, wherein a first crystal with noncritical phase matching is provided for generating a first new frequency and a second crystal with critical phase matching is provided for generating a second new frequency by frequency mixing, wherein a pair of laser beams generated in the first crystal has laser beams which are polarized perpendicular to one another, one of which laser beams, as extraordinary polarized laser beam, undergoes a walk-off in the second crystal. A birefringent crystal is arranged between the two nonlinear optical crystals, which birefringent crystal is penetrated by the pair of laser beams and in which nonlinear optical characteristics are prevented, so that the pair of laser beams exits from the birefringent crystal with unchanged frequencies. In the birefringent crystal, the extraordinary polarized laser beam undergoes a walk-off which is directed opposite to the walk-off occurring in the crystal for frequency mixing.

In another construction of the invention, a noncritically phase-matched nonlinear optical crystal, together with a birefringent correction crystal, forms a compact optical device for highly-effective generation of a new frequency from a fundamental frequency, which new frequency, together with the fundamental frequency, is suitable for further nonlinear optical processing, in that, due to different propagation characteristics in the birefringent crystal, the two laser beams exiting with unchanged frequencies have an offset relative to one another which can be effectively adjusted spatially and, with sufficiently short pulses, also temporally.

The conversion efficiency in subsequent nonlinear processing can be substantially increased by a device of this type.

Another construction of the invention concerns a device for frequency mixing with laser beams which run collinearly and are polarized perpendicular to one another and with a nonlinear optical crystal in which one of the two laser beams, as extraordinary polarized laser beam, undergoes a walk-off. A birefringent correction crystal for walk-off which is penetrated by the laser beams is placed in front of the nonlinear optical crystal in which a type II interaction takes place. Since the correction crystal has no nonlinear optical characteristics, the laser beams exit from this crystal with unchanged frequencies and, because of different propagation characteristics in the birefringent crystal, have an offset relative to one another which can be effectively adjusted spatially and temporally and by means of which the walk-off can be corrected in the crystal for frequency mixing.

The birefringent crystal can be provided for compensating the spatial walk-off and temporal walk-off in pulsed laser beams or for compensating only the spatial walk-off or the temporal walk-off.

The mutual offset of the two laser beams which is determined by the spatial walk-off when exiting from the birefringent optical crystal can be adjusted in such a way by the selection of crystalline material, the angle between the optical crystal axis and the propagation direction of the laser beams, and the optical path length that a maximum beam overlap is generated in the crystal for frequency mixing.

In an advantageous construction of the invention, the offset by which the two laser beams exit the birefringent optical crystal and enter the crystal for frequency mixing is adjusted so as to be approximately identical to the offset which is generated for these laser beams in the crystal for frequency mixing.

When the birefringent crystal is provided only for compensating a temporal walk-off effect, the birefringent crystal should be made of a material with a different group velocity for the two laser beams and have an optical path length which compensates for a transit time difference for the two laser beam pulses to be overlapped in the crystal for frequency mixing.

Finally, depending on the intended effect of the pulse delay or pulse acceleration, the birefringent optical crystal can be negative uniaxial or positive uniaxial.

The invention will be described more fully in the following with reference to the schematic drawings.

### BRIEF DESCRIPTION OF THE DRAWINGS

In the drawings:

FIG. 1 shows a block diagram for a laser radiation source with extracavity frequency conversion;

FIG. 2 shows a frequency conversion unit constructed according to the invention;

FIG. 3 shows the birefringent crystal for compensating the spatial and temporal walk-off;

FIG. 4 shows curves illustrating the dependence of the walk-off upon the angle Θ for birefringent crystals of different length; and

FIG. 5 is a block diagram of another embodiment of the invention.

### DESCRIPTION OF THE PREFERRED EMBODIMENTS

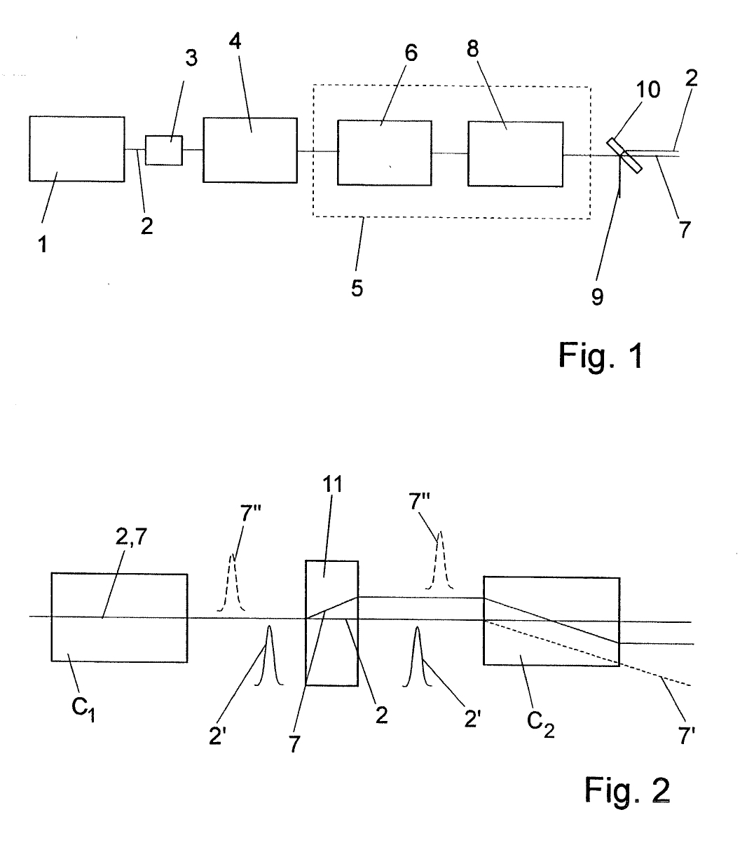

The arrangement shown in FIG. 1 relates to a laser radiation source with extracavity frequency tripling (third harmonic generation, THG), in particular to a pulsed laser in the form of a UV solid state laser with an Nd:YVO₄ laser crystal which can be used, for example, for exposure and drilling of printed circuit boards, for cutting silicon wafers or for stereo lithography. The requirements for the laser radiation source with respect to laser output, efficiency of UV generation, beam quality and longevity are particularly strict in the aforementioned applications.

Frequency tripling of an Nd:YVO₄ laser is usually carried out by SHG in the green range (λ₂=532 nm) and subsequent SFG of the green laser radiation with the residual fundamental laser frequency. The third harmonic occurring in this way has a wavelength of λ₃=355 nm.

A laser beam which proceeds from a Q-switched or mode-coupled laser oscillator 1 and has a fundamental frequency 2 is advantageously amplified in a laser amplifier 4 after passing through an optical isolator 3. The gain can be selected by suitable dimensioning such that the subsequent frequency conversion is carried out in a frequency conversion unit 5 in a particularly effective manner and the UV output required for the respective application is achieved.

The extracavity frequency conversion unit 5 comprises a unit 6 for generating the second harmonic 7 with a first nonlinear optical crystal C₁ and a unit 8 for generating the third harmonic 9 with a second nonlinear optical crystal C₂. Suitable dichroic mirrors or dispersive elements 10 separate the radiation of the third harmonic 9 from the rest of the fundamental laser frequency 2 and the second harmonic 7.

According to FIG. 2, the frequency conversion unit 5 contains two LBO crystals (lithium triborate LiB₃O₅) for the two nonlinear optical crystals C₁ and C₂. While the noncritically phase-matched crystal C₁ has an orientation of Θ=90° and φ=0° at a phase matching temperature of approximately 150° C., crystal C₂, with Θ≈90° and φ=90°, is critically phase matched at room temperature.

The laser beams of the fundamental laser frequency 2 and of the second harmonic 7 are polarized perpendicular to one another and exit the crystal C₁ collinearly due to the noncritical phase matching.

The ordinary polarized original laser beam in the present embodiment example and the extraordinary polarized second harmonic are superimposed in the second nonlinear optical crystal C₂ and generate the third harmonic 9 by nonlinear interaction.

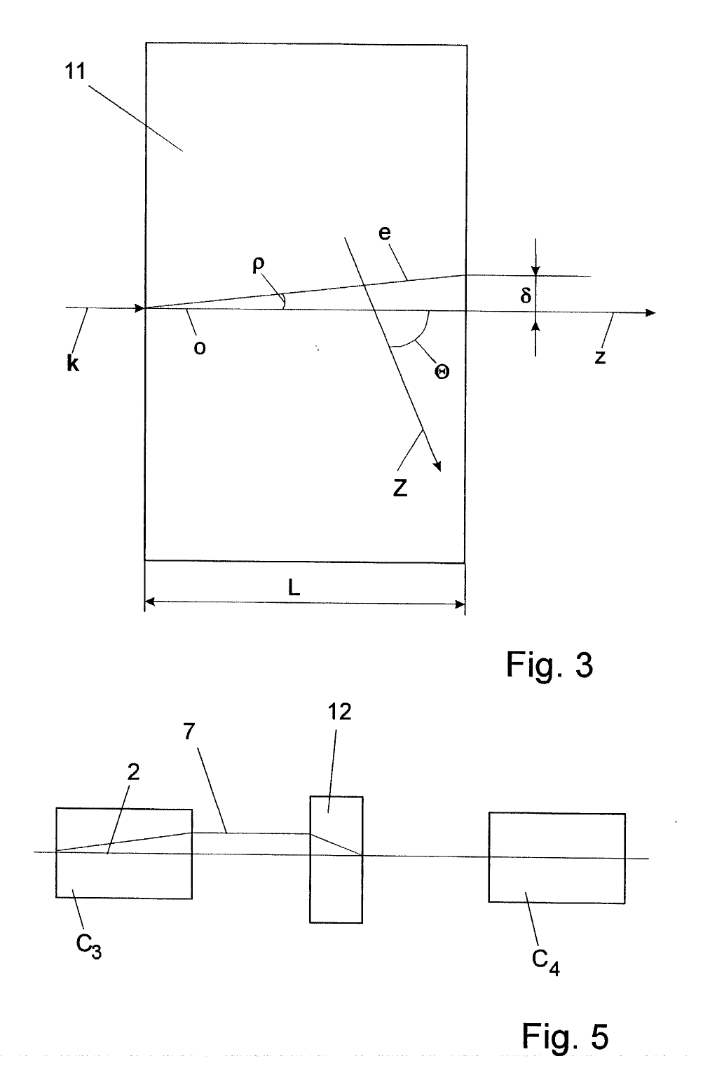

However, before the nonlinear interaction is brought about, the two laser beams 2 and 7 penetrate a birefringent crystal 11 which is arranged between the two nonlinear crystals C₁ and C₂ for compensation of a spatial walk-off and a temporal walk-off in crystal C₂, so that an increased interaction length is achieved in crystal C₂. The birefringent crystal 11 either has such a material composition or is oriented in such a way that the two laser beams 2 and 7 do not undergo any nonlinear frequency conversion and exit again from the crystal 11 with unchanged frequencies. However, crystal 11 is arranged in such a way that the extraordinary polarized laser beam, in this case the second harmonic 7, suffers a walk-off and is deflected from the propagation direction of the laser radiation of the fundamental frequency 2 at a walk-off angle ρ, so that the ordinary polarized light beam and the extraordinary polarized light beam exit from the birefringent crystal 11 at a distance δ. This state of affairs is shown in FIG. 3 for a negative uniaxial birefringent crystal, where k is the wave vector, o is the ordinary polarized laser beam, e is the extraordinary polarized laser beam, Θ is the angle between the optical axis Z of the crystal 11 on which the ordinary beam and extraordinary beam have the same index of refraction, and z is the propagation direction of the laser radiation along the beam axis.

The curve of an extraordinary polarized laser beam 7′ shown in dashed lines illustrates the effect of the compensation of the spatial walk-off by the crystal 11. Without compensation, an immediate spreading apart of the two laser beams would result in a reduced interaction length. On the other hand, the deflections for the extraordinary polarized laser beam 7 in crystal 11 and in the nonlinear crystal C₂, which deflections are directed opposite to one another, compensate for this effect in the manner shown. The ordinary polarized laser beam and the extraordinary polarized laser beam intersect approximately in the center of crystal C₂ at the distance δ generated in the present example.

Compensation of this type is not limited to pulsed operation of the laser. But nonlinear optical processes are particularly effective when the laser radiation with the fundamental laser frequency is pulsed with a high peak output in the kW range. In every case, this type of compensation is advantageous for nanosecond pulses of a Q-switched laser as well as for picosecond pulses of a mode-coupled laser.

With pulses in the picosecond range or in a lower range, another effect occurs in addition to the spatial walk-off, wherein the pulses of the ordinary polarized laser beam are offset in time with respect to those of the extraordinary polarized laser beam, which can be referred to as temporal walk-off. This is illustrated by the dashes used to show a pulse 7″ which is shifted relative to a pulse 2′. This effect which occurs already in the first nonlinear crystal C₁ can also be found in the second nonlinear crystal C₂ and can likewise be compensated by means of the birefringent crystal 11 in that the pulse 7″ is shifted temporally relative to the pulse 2′.

In the present case with two LBO crystals, the pulse of the second harmonic in the two nonlinear crystals C₁ and C₂ is slower than the pulse of the fundamental laser frequency. Therefore, because of the special birefringent characteristics of the crystal 11 and the consequent higher group velocity of the pulse of the second harmonic compared to the pulse of the fundamental laser frequency, the pulse 7″ obtains the corresponding shape relative to pulse 2′.

In another preferred construction, the birefringent crystal 11 is constructed in such a way that an exclusively temporal influence of the pulses is brought about, e.g., a delay in the pulses of the extraordinary polarized laser beam relative to those of the ordinary polarized laser beam, but there is no spatial walk-off. This adjusting possibility is particularly relevant when the second nonlinear crystal C₂ is noncritically phase-matched like the first crystal.

In the following, the birefringent crystal 11 and its effect in connection with the two nonlinear crystals C₁ and C₂ is described more fully using the example of third harmonic generation (THG, 355 nm) in an Nd:YVO₄ laser from an infrared fundamental laser frequency (1064 nm) and a green second harmonic (SHG, 532 nm) generated therefrom by two LBO crystals.

The table contains measurements for the walk-off angle ρ and for the reciprocal group velocity mismatch GVM_{IR-GR} as a measurement for the spreading apart of the light pulses of the infrared fundamental laser radiation and the green frequency-doubled radiation. The latter is defined by the following equation:

GVM_{IR-GR}=(1/ν_{IR}−1/ν_{GR}),

where v is the group velocity, and the negative sign indicates that the green pulse runs behind the infrared pulse.

| | SHG with LBO crystal C₁ | THG with LBO crystal C₁ |
|---|---|---|
| | and noncritical phase matching | and critical phase matching |
| Walk-off angle (ρ/mrad) | 0 | 9.32 |
| GVM_{IR-GR}/(ps/mm) | −0.044 | −0.107 |

With typical lengths of the LBO crystals C₁ and C₂ of approximately 10 to 20 mm, the green pulse accordingly falls behind the infrared pulse by about 1.5 to 3 ps. The spatial walk-off δ_{C2} at the output of the LBO crystal C₂ is about 95 to 190 μm.

The birefringent crystal 11, as compensator of the spatial walk-off δ_{C2} occurring in the LBO crystal C₂, must itself cause a spatial walk-off δ_{C11} of approximately equal magnitude. A separation of the extraordinary polarized laser beam and ordinary polarized laser beam by δ_{C2}/2 is also advantageous, for example; but the optimal value depends on concrete conditions such as laser beam diameter and pulse output. In the present application example, this value can be determined empirically and an optimum conversion efficiency should serve as criterion.

If the birefringent crystal 11 must compensate simultaneously for temporal walk-off in addition to spatial walk-off, then, in addition to the selection of a suitable birefringent material which is transparent for both wavelengths and where v_{IR}<v_{GR}, its length must also be suitably dimensioned.

With an extraordinary polarized green laser beam, negative uniaxial crystals are particularly suitable as compensator material, where nₒ>nₑ (nₒ=index of refraction for the ordinary polarized laser radiation, nₑ=nₑ(Θ=90°)=index of refraction for the extraordinary polarized laser radiation).

With the inverse group velocity ratios (vₒ<vₑ) of the two interacting laser beams, positive uniaxial crystals can be used. This is the case for the example of sum frequency generation: λ₁=1535 nm, λ₂=1064 nm→λ₃=628.5 nm) because v_{1,o}<v_{2,e}.

On the other hand, when only a spatial walk-off is to be compensated, which is sufficient in the case of interaction of comparatively long nanosecond pulses, the birefringent crystal 11 can be negative uniaxial or positive uniaxial.

According to the present embodiment example, a negative uniaxial calcite crystal which is transparent for both wavelengths (532 nm, 1064 nm) is used for the birefringent crystal 11. Further, for calcite: nₒ=1.6629, nₑ=1.4885 and GVM_{IR-GR}=0.5 ps/mm.

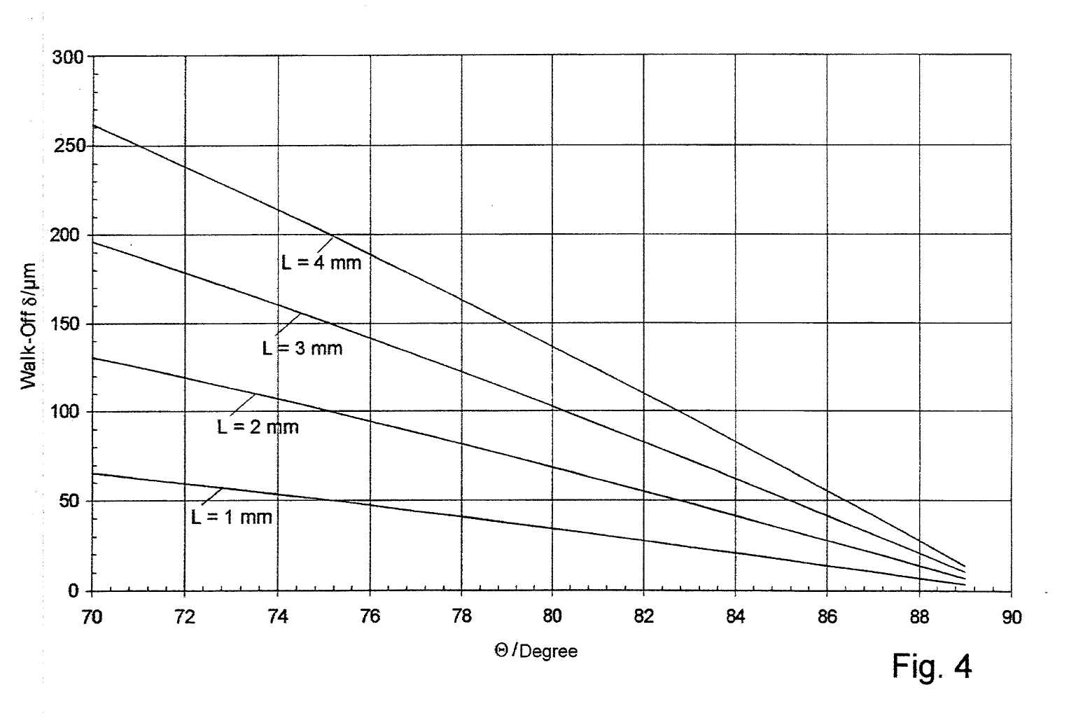

The curves shown in FIG. 4 for the spatial walk-offδ at the output of the calcite crystal depending on angle Θ for four different crystal lengths are used for the dimensioning of the birefringent crystal 11.

When a spatial walk-off δ=100 μm is required for optimal conversion effectiveness, e.g., a crystal with L=2 mm and Θ≈75°, or L=3 mm and Θ≈80°, or L=4 mm and Θ≈83° would be considered.

However, when it is desirable to simultaneously influence the pulses in a very definite manner with respect to time, particularly the delay of the pulses of the extraordinary polarized laser beam to compensate for the temporal walk-off, L is determined; for example, if the transit time of the green pulse should be 1.5 ps shorter than that of the infrared pulse, a crystal length of L=3 mm is to be selected for the present example.

In another embodiment example according to FIG. 5 for the frequency conversion unit 5, two nonlinear optical crystals C₃ and C₄ are provided, where the first crystal C₃ is critically phase-matched and the second crystal C₄ is noncritically phase-matched.

The laser beams of the fundamental laser frequency 2 and of the second harmonic 7 are polarized perpendicular to one another, and the extraordinary polarized laser beam of the second harmonic 7 suffers a walk-off because of the critical phase matching and exits the crystal C₃ with an offset to the laser beam of the fundamental laser frequency 2. The effect (not shown) of the temporal walk-off is analogous to that described above. For optimal interaction in the second nonlinear optical crystal C₄, a birefringent crystal 12 is arranged between the two crystals C₃ and C₄ to compensate for the spatial and temporal walk-off in crystal C₃. The birefringent crystal 12 again either has a such a material composition or is arranged so as to be oriented in such a way that the two laser beams 2 and 7 do not undergo any nonlinear frequency conversion and exit from the crystal 12 without a change in frequency. However, crystal 12 is arranged in such a way that the extraordinary polarized laser beam, in this case, the second harmonic 7, suffers a spatial walk-off in the opposite direction to the first crystal C₃, so that both laser beams exit coaxially from the birefringent crystal 12. In order to compensate for the temporal walk-off, the pulses (not shown) are shifted with respect to time by means of the birefringent crystal 12 in such a way that an optimal nonlinear interaction is made possible in crystal C₄.

Of course, the invention is not limited to the embodiment examples described herein. For example, conversions can be carried out in other frequencies and with other crystals. What is essential for the invention is the nonlinear frequency conversion of two laser beams, one of which undergoes a walk-off in one of the crystals. The birefringent crystal can also be made of different materials, for example, an α-BBO crystal.

It is also possible to use additional focusing optics. The modifications required for this can be carried out in a manner known in the art and do not interfere with the application of the inventive idea.

While the foregoing description and drawings represent the present invention, it will be obvious to those skilled in the art that various changes may be made therein without departing from the true spirit and scope of the present invention.

What is claimed is:

1. A device for the frequency conversion of a fundamental laser frequency to other frequencies with successively arranged nonlinear optical crystals, comprising:
a first crystal being provided for generating a first new frequency;
a second crystal being provided for generating a second new frequency by frequency mixing;
a pair of laser beams generated in the first crystal having laser beams which are polarized perpendicular to one another, one of said laser beams, as extraordinary polarized laser beam, undergoing a walk-off in one of the two nonlinear optical crystals; and
a birefringent crystal being arranged between the two nonlinear optical crystals, said birefringent crystal being penetrated by the pair of laser beams and in which nonlinear optical characteristics are prevented, so that the pair of laser beams exits from the birefringent crystal with unchanged frequencies, and wherein the extraordinary polarized laser beam undergoes a walk-off in the birefringent crystal, which walk-off is directed opposite to the walk-off occurring in one of the two crystals.

2. A solid state laser with extracavity nonlinear optical crystals for the frequency conversion of a fundamental laser frequency into other frequencies, comprising:
a first crystal with noncritical phase matching being provided for generating a first new frequency;
a second crystal with critical phase matching being provided for generating a second new frequency by frequency mixing;
a pair of laser beams generated in the first crystal having laser beams which are polarized perpendicular to one another, one of said laser beams, as extraordinary polarized laser beam, undergoing a walk-off in the second crystal; and
a birefringent crystal being arranged between the two nonlinear optical crystals, which birefringent crystal is penetrated by the pair of laser beams and in which nonlinear optical characteristics are prevented, so that the pair of laser beams exits from the birefringent crystal with unchanged frequencies, and wherein the extraordinary polarized laser beam undergoes a walk-off in the birefringent crystal, which walk-off is directed opposite to the walk-off in the crystal for frequency mixing.

3. The device according to claim 1, wherein the birefringent crystal is provided for compensating the spatial walk-off and temporal walk-off of pulsed laser radiation.

4. The device according to claim 1, wherein the birefringent crystal is provided for compensating the spatial walk-off.

5. The device according to claim 3, wherein the mutual offset of the two laser beams which is determined by the spatial walk-off when exiting from the birefringent crystal is adjusted in such a way by the selection of crystalline material, the angle between the optical crystal axis and the propagation direction of the laser beams, and the optical path length that a maximum beam overlap is generated in the crystal for frequency mixing.

6. The device according to claim 5, wherein the offset by which the two laser beams exit the birefringent crystal and enter the crystal for frequency mixing is approximately identical to the offset which is generated for these laser beams in the crystal for frequency mixing.

7. The device according to claim 1, wherein the birefringent crystal is provided only for compensating for a temporal walk-off effect of pulsed laser radiation.

8. The device according to claim 3, wherein the birefringent crystal is made of a material with a different group velocity for the two laser beams and has an optical path length which compensates for a transit time difference for the two laser beam pulses to be overlapped in the crystal for frequency mixing.

9. The device according to claim 1, wherein the birefringent crystal is a negative uniaxial crystal.

10. The device according to claim 1, wherein the birefringent crystal is a positive uniaxial crystal.

11. A device for second harmonic generation from a laser beam with a fundamental laser frequency with a noncritically phase-matched nonlinear optical crystal, comprising that the nonlinear optical crystal is followed by a birefringent crystal in which the laser beams of the fundamental laser frequency and of the second harmonic enter collinearly and through which the two laser beams exiting with unchanged frequencies, due to different propagation characteristics in the birefringent crystal, have an offset relative to one another which can be effectively adjusted spatially and temporally.

12. A device for frequency mixing with laser beams which run collinearly and are polarized perpendicular to one another and with a nonlinear optical crystal in which one of the two laser beams, as extraordinary polarized laser beam, undergoes a walk-off, comprising that a birefringent crystal which is penetrated by the laser beams and in which nonlinear optical characteristics are prevented is placed in front of the nonlinear optical crystal, so that the laser beams exit from this crystal with unchanged frequencies and, because of different propagation characteristics in the birefringent crystal, have an offset relative to one another which can be effectively adjusted spatially and temporally and by which the walk-off can be corrected in the crystal for frequency mixing.
